(19) United States
(12) Patent Application Publication
(10) Pub. No.: US 2026/0167790 A1
(43) Pub. Date: Jun. 18, 2026

(54) PROCESS FOR PREPARING POLARIZER

(71) Applicant: DONGWOO FINE-CHEM CO. LTD., Iksan-si (KR)

(72) Inventors: Joongman PARK, Iksan-si (KR); Kyoungmoon JUNG, Iksan-si (KR); Se Won LEE, Iksan-si (KR); Sungmin MOON, Iksan-si (KR); Jeong Bin OH, Iksan-si (KR)

(73) Assignee: DONGWOO FINE-CHEM CO., LTD., Iksan-si (KR)

(21) Appl. No.: 19/414,701

(22) Filed: Dec. 10, 2025

(30) Foreign Application Priority Data
Dec. 13, 2024 (KR) 10-2024-0185917

(51) Int. Cl. C08J 7/12; B32B 17/10; B32B 27/08; B32B 27/36; C08J 5/18; C08J 7/02; G02B 1/14; G02B 5/30

(52) U.S. Cl. CPC C08J 7/123; B32B 17/10; B32B 27/08; B32B 27/36; C08J 5/18; C08J 7/02; G02B 1/14; G02B 5/30; B32B 2307/42; C08J 2329/04

(57) ABSTRACT

The present invention relates to a process for preparing a polarizer, comprising the steps of swelling, dyeing, crosslinking, complementary dyeing, cleaning, and drying a film for forming a polarizer, which comprises the step of irradiating, between the steps of cleaning and drying, infrared rays with an energy of 0.16 to 0.72 J/cm² per unit area to the film for forming a polarizer. According to the preparation process of the present invention, a high heat-resistant polarizer with little color change before and after heat resistance treatment at high temperatures of 110° C. or higher can be prepared.

### CROSS REFERENCE TO RELATED APPLICATIONS

This application claims priority based on Korean Patent Application No. 10-2024-0185917, filed Dec. 13, 2024, the entire content of which is incorporated herein by reference in its entirety.

### TECHNICAL FIELD

The present invention relates to a process for preparing a polarizer. More particularly, the present invention relates to a process for preparing a polarizer with excellent heat resistance at high temperatures of 110° C. or higher.

### BACKGROUND ART

Polarizing plates used in liquid crystal displays and the like are generally formed by attaching a protective film to one or both surfaces of the polarizer. The polarizer is prepared by a uniaxial stretching process of a polyvinyl alcohol (PVA) resin film, a process for dyeing the polyvinyl alcohol resin film with a dichroic pigment and adsorbing the dichroic pigment, a process for crosslinking the polyvinyl alcohol resin film with adsorbed dichroic pigment by treating it with a boric acid aqueous solution, and a washing process.

A polarizer using iodine as the dichroic pigment in the dyeing process is called an iodine-based polarizer, and a polarizer using a dichroic dye is called a dye-based polarizer. Among these, iodine-based polarizers exhibit higher transmittance and higher polarization efficiency (high contrast) compared to dye-based polarizers and are widely used.

However, while iodine-based polarizers exhibit superior optical properties compared to dye-based polarizers, their optical durability is low. For example, leaving an iodine-based polarizer or a polarizing plate containing such a polarizer exposed to dry heat causes problems such as reduced transmittance or discoloration.

Recently, as the application fields of liquid crystal displays expand and surrounding technologies advance, interest in automotive displays has increased. However, polarizing plates used in automotive displays require enhanced heat resistance compared to those used in conventional TVs and mobile devices.

Korean Patent Publication No. 2019-0004228 discloses a method for increasing the heat resistance of a polarizer by irradiating electromagnetic waves onto a crosslinked polyvinyl alcohol resin film. However, polarizers manufactured using the above method still exhibit significant color changes before and after heat resistance treatment at temperatures above 110° C., necessitating the development of polarizers with superior high-temperature heat resistance.

### DISCLOSURE

### Technical Problem

It is an object of the present invention to provide a process for preparing a polarizer with excellent heat resistance at temperatures of 110° C. or higher.

Another object of the present invention is to provide a polarizer manufactured by the above preparation process.

Yet another object of the present invention is to provide a polarizing plate having a protective film laminated on at least one surface of the above polarizer.

### Technical Solution

An aspect of the present invention provides a process for preparing a polarizer, comprising the steps of swelling, dyeing, crosslinking, complementary dyeing, cleaning, and drying a film for forming a polarizer, which comprises the step of irradiating between the steps of cleaning and drying, infrared rays with an energy of 0.16 to 0.72 J/cm² per unit area to the film for forming a polarizer.

In one embodiment of the present invention, the infrared rays may have a wavelength of 1 to 5 μm.

In one embodiment of the present invention, irradiation time of the infrared rays may be 0.1 to 5 minutes.

In one embodiment of the present invention, the film for forming a polarizer may be a polyvinyl alcohol film.

Another aspect of the present invention provides a polarizer prepared by the above preparation process.

Yet another aspect of the present invention provides a polarizing plate having a protective film laminated on at least one surface of the above polarizer.

Still another aspect of the present invention provides an automotive display comprising the above polarizing plate.

Yet another aspect of the present invention provides a smart window comprising the above polarizing plate.

### Advantageous Effects

According to the preparation process of the present invention, a polarizer can be prepared that exhibits little color change even after prolonged exposure to high temperatures of 110° C. or higher, enabling its effective use in automotive displays or smart windows.

### BEST MODE

Hereinafter, the present invention will be described in more detail.

One embodiment of the present invention relates to a process for preparing a polarizer, comprising the steps of swelling, dyeing, crosslinking, complementary dyeing, cleaning, and drying a film for forming a polarizer, which comprises the step of irradiating, between the steps of cleaning and drying, infrared rays with an energy of 0.16 to 0.72 J/cm² per unit area to the film for forming a polarizer.

By including the infrared irradiation step, the process for preparing a polarizer according to the present invention can improve the high-temperature heat resistance of the prepared polarizer, and in particular, can prepare a high heat-resistant polarizer exhibiting little color change before and after heat resistance treatment at high temperatures of 110° C. or higher.

The film for forming a polarizer is not specifically limited in type as long as it is a film that can be dyed with a dichroic material, such as iodine or the like. Examples include polyvinyl alcohol films, partially saponified polyvinyl alcohol films; hydrophilic polymer films such as polyethylene terephthalate films, ethylene-vinyl acetate copolymer films, ethylene-vinyl alcohol copolymer films, cellulose films, and partially saponified films thereof, or polyene-oriented films such as dehydrated polyvinyl alcohol films, dehydrochlorinated polyvinyl chloride films, etc. Among these, polyvinyl alcohol films are preferred because they not only have an excellent effect of enhancing the uniformity of polarization intensity within a plane but also exhibit excellent dye affinity for iodine.

Polyvinyl alcohol films having a polymerization degree of typically 500 to 10,000, preferably 1,000 to 6,000, and more preferably 1,400 to 4,000 can be used. In the case of saponified polyvinyl alcohol films, the saponification degree may be preferably 95.0 mol % or higher, more preferably 99.0 mol % or higher, and even more preferably 99.9 mol % or higher, in terms of solubility.

The thickness of the polarizer is not particularly limited, but is within a range of, for example, 5 to 40 μm, preferably within a range of 10 to 30 μm, and more preferably within a range of 15 to 25 μm.

In a process for preparing a polarizer according to one embodiment of the present invention, a polarizer prepared through a swelling step, a dyeing step, a crosslinking step, and a complementary dyeing step is cleaned, irradiated with infrared rays, and then dried to prepare the polarizer.

The swelling step involves immersing a pre-stretched film for forming a polarizer in a swelling bath filled with a swelling aqueous solution prior to dyeing. This step is for removing impurities such as dust or anti-blocking agents deposited on the surface of the film for forming a polarizer, swelling the film for forming a polarizer to enhance stretching efficiency, and preventing dyeing unevenness to improve the physical properties of the polarizer.

Water (pure or deionized) can typically be used alone as the swelling aqueous solution. Adding a small amount of glycerin or potassium iodide to this solution can improve both the swelling and processability of the film for forming a polarizer. For a 100% by weight swelling aqueous solution, the glycerin content is preferably 5% by weight or less, and the potassium iodide content is preferably 10% by weight or less.

The temperature of the swelling bath is preferably 20 to 45° C., and more preferably 25 to 40° C. The duration of the swelling step (swelling bath immersion time) is preferably 180 seconds or less, and more preferably 120 seconds or less. When the immersion time is within the above range, excessive swelling leading to saturation can be suppressed. This prevents breakage due to softening of the film for forming a polarizer and ensures uniform adsorption of iodine during the dyeing step, thereby improving the polarization degree.

A stretching step may be performed together with the swelling step, and in this case, a stretching ratio of about 1.1 to 3.5 times is desirable.

The swelling step may be omitted, and swelling may be performed simultaneously during the dyeing step.

The dyeing step involves immersing the film for forming a polarizer into a dyeing bath filled with a dyeing aqueous solution containing iodine, thereby adsorbing iodine onto the film for forming a polarizer.

The dyeing aqueous solution may contain water, a water-soluble organic solvent, or a mixed solvent thereof, and iodine. The iodine content is preferably 0.4 to 400 mmol/L, more preferably 0.8 to 275 mmol/L, and even more preferably 1 to 200 mmol/L.

To further enhance dyeing efficiency, an iodide may be further included as a solubilizing agent. As the iodides, potassium iodide, lithium iodide, sodium iodide, zinc iodide, aluminum iodide, lead iodide, copper iodide, barium iodide, calcium iodide, tin iodide, titanium iodide, etc. can be used alone or in combination of two or more, and among these, potassium iodide is preferred due to its high solubility in water. The content of iodide is preferably 0.01 to 10 weight % based on 100 weight % of the dyeing aqueous solution, and more preferably 0.1 to 5 weight %.

The temperature of the dyeing bath is preferably 5 to 42° C., and more preferably 10 to 35° C. The immersion time of the film for forming a polarizer within the dyeing bath is not particularly limited, and is preferably 1 to 20 minutes, more preferably 2 to 10 minutes.

A stretching step may be performed together with the dyeing step, and in this case, the cumulative stretching ratio is preferably 1.1 to 4.0 times. In this specification, “cumulative stretching ratio” denotes the product of the stretching ratios in each step.

The crosslinking step involves immersing the dyed film for forming a polarizer in a crosslinking aqueous solution to fix the adsorbed iodine molecules so that the dyeability due to physically adsorbed iodine molecules is not reduced by the external environment. While dichroic dyes do not often leach out in humid environments, iodine molecules frequently dissolve or sublimate depending on the environment if the crosslinking reaction is unstable, necessitating a sufficient crosslinking reaction.

The crosslinking aqueous solution comprises water as the solvent, a boron compound such as boric acid or sodium borate, an iodide, and a metal nitrate, and may further comprise an organic solvent mutually soluble with water.

The boron compound improves processability by suppressing wrinkling during processing by forming short crosslinks and imparting rigidity, and it also serves to form iodine orientation.

The content of the boron compound is preferably 1 to 10 wt % based on 100 wt % of the crosslinking aqueous solution, and more preferably 2 to 6 wt %. When the content is less than 1 wt %, the crosslinking effect of the boron compound decreases, making it difficult to impart rigidity. When exceeding 10 wt %, the crosslinking reaction of the inorganic crosslinking agent becomes excessively activated, making it difficult for the crosslinking reaction of the organic crosslinking agent to proceed effectively.

The iodide is used to ensure uniformity of polarization degree within the polarizer plane and to prevent desorption of dyed iodine. The iodide may be the same as that used in the dyeing step, and its content may be 0.05 to 15 wt % based on 100 wt % of the crosslinking aqueous solution, preferably 0.5 to 11 wt %. If the content is less than 0.05 wt %, iodine ions in the film may leach out, increasing transmittance and altering the polarizer's color value, necessitating additional processes for adjustment. If it exceeds 15 wt %, iodine ions in the aqueous solution may permeate into the film, causing a decrease in transmittance.

The metal nitrate is used to enhance the heat resistance of the polarizer.

The metal nitrate may be a nitrate of a metal selected from the group consisting of Li, Na, K, Rb, Cs, Ag Mg, Ca, Sr, Ba, Cu, Zn, Fe, Co, Ni, Ru, Rh, Pd, Zr, Pt, Al, Ga, In, Ti, La, Ce, Eu, Gd, Y, Nd, Sm, Pr, Tm, Er, Sn, Zr, V, Cr, Mo, and Mn. From the perspective of high-temperature durability, a nitrate of a metal selected from the group consisting of Zn, Cu, Al, Mg, and Zr is preferred, and zinc nitrate is more preferred.

The content of the metal nitrate may be 0.1 to 10 wt %, preferably 0.5 to 7.0 wt %, based on 100 wt % of the crosslinking aqueous solution. If the content is less than 0.1 wt %, the effect of the metal nitrate may be insufficient, and if it exceeds 10 wt %, excessive chemical bonding between the metal salt and polyvinyl alcohol may cause breakage issues and reduce production efficiency.

The temperature of the crosslinking bath is 20 to 70° C., and the immersion time of the film for forming a polarizer in the crosslinking bath can be 1 second to 15 minutes, preferably 5 seconds to 10 minutes.

Together with the crosslinking step, a stretching step may be performed. In this case, it is desirable to stretch such that the total cumulative stretching ratio is 3.0 to 8.0 times.

As described above, the stretching step may be performed together with the swelling step, dyeing step, and crosslinking step, or it may be performed as an independent stretching step using a separate stretching bath filled with a stretching aqueous solution after the crosslinking step.

The complementary dyeing step is a step for additionally fixing iodine molecules that were insufficient during the crosslinking step.

The complementary dyeing aqueous solution comprises a boron compound. By containing a boron compound, the above complementary dyeing aqueous solution can enhance crosslinking efficiency to suppress wrinkling during processing and form iodine orientation to improve optical properties.

The content of the boron compound may be 0.5 to 10 wt % based on 100 wt % of the complementary dyeing aqueous solution, and preferably 1 to 5 wt %. If the content is less than 0.5 wt %, the polarization degree may decrease, and if it exceeds 10 wt %, the shrinkage force may increase.

The boron compound may be the same as that used in the crosslinking step.

The complementary dyeing aqueous solution may comprise water as a solvent and an organic solvent mutually soluble with water, and may further comprise a small amount of iodide to ensure uniformity of polarization degree within the polarizer plane and to prevent desorption of the dyed iodine.

The content of the iodide may be 1 to 15 wt % based on 100 wt % of the complementary dyeing aqueous solution, and preferably 5 to 11 wt %. If the content is less than 1 wt %, the polarization degree decreases, and if it exceeds 15 wt %, the heat resistance decreases, and reddening may occur upon prolonged exposure to high temperature.

The same iodide used in the dyeing step may be used.

The temperature of the complementary dyeing bath is not specifically limited but may be, for example, 20 to 70° C., and preferably 40 to 60° C.

The immersion time of the film for forming a polarizer in the complementary dyeing bath is not specifically limited and may be, for example, from 1 second to 15 minutes, and preferably from 5 seconds to 10 minutes.

A stretching step may be performed together with the complementary dyeing step. In this case, the stretching ratio of the complementary dyeing step may be 1 to 1.15 times, and preferably 1.01 to 1.1 times.

The cumulative stretching ratio of the above complementary dyeing step may be 1.5 to 7 times, and preferably 1.7 to 6 times. If the cumulative stretching ratio is less than 1.5 times, the effect of increasing crosslinking efficiency may be negligible. If it exceeds 7 times, excessive stretching may cause film breakage and reduce production efficiency.

The cleaning step involves immersing the film for forming a polarizer, which has completed crosslinking and stretching, into a cleaning bath filled with a cleaning aqueous solution to remove unnecessary residues such as boric acid that adhered to the film for forming a polarizer during previous steps.

The cleaning aqueous solution may be water, to which iodide may also be added.

The temperature of the cleaning bath is preferably 10 to 60° C., and more preferably 10 to 40° C. The duration of the cleaning step is typically 1 to 60 seconds, preferably 3 to 30 seconds, and more preferably 5 to 20 seconds.

The infrared irradiation step is performed by applying an energy of 0.16 to 0.72 J/cm² per unit area to the cleaned film for forming a polarizer. If the energy applied by the infrared irradiation is less than 0.16 J/cm², the effect of improving high-temperature heat resistance is negligible, and if it exceeds 0.72 J/cm², breakage of the film for forming a polarizer may occur.

Furthermore, from the perspective of enhancing high-temperature heat resistance and preventing film breakage, the wavelength of the infrared radiation may be 1 to 5 μm, and the duration of the infrared irradiation step may be 0.1 to 5 minutes.

The infrared irradiation step is preferably performed in the cleaning bath immediately after cleaning the film for forming a polarizer.

The drying step involves drying the film for forming a polarizer irradiated with infrared rays after cleaning. This step further improves the orientation of the dyed iodine molecules through neck-in by the drying process, thereby obtaining a polarizer with superior optical properties.

Drying methods include natural drying, air drying, heat drying, far-infrared drying, microwave drying, and hot air drying. Recently, microwave drying, which activates only the water within the film for drying, has been newly utilized, while hot air drying is typically the primary method. For example, hot air drying can be performed at 20 to 90° C. for 1 to 10 minutes. The drying temperature is preferably low to prevent degradation of the polarizer, more preferably 80° C. or lower, and even more preferably 70° C. or lower.

One embodiment of the present invention relates to a polarizer prepared by the above preparing process.

One embodiment of the present invention provides a polarizing plate having a protective film laminated on at least one surface of the polarizer.

For a protective film, there are no specific restrictions as long as the film exhibits excellent transparency, mechanical strength, thermal stability, moisture barrier properties, and isotropy. Specific examples include films composed of thermoplastic resins, for example polyester resins such as polyethylene terephthalate, polyethylene isophthalate, and polybutylene terephthalate; cellulose resins such as diacetyl cellulose and triacetyl cellulose; polycarbonate resins; acrylic resins such as polymethyl (meth)acrylate and polyethyl (meth)acrylate; styrene resins such as polystyrene and acrylonitrile-styrene copolymers; polyolefin resins such as polyethylene, polypropylene, polyolefins with cyclo or norbornene structures, and ethylene-propylene copolymers; vinyl chloride resins; polyamide resins such as nylon and aromatic polyamides; imide resins; polyether sulfone resins; sulfone resins; polyether ketone resins; polyphenylene sulfide resins; vinyl alcohol resins; vinylidene chloride resins; vinyl butyral resins; allylate resins; polyoxymethylene resins; epoxy resins, and a film composed of a blend of the above thermoplastic resins may also be used. Additionally, a film made from thermosetting resins such as (meth)acrylic, urethane, epoxy, or silicone, or from UV-curable resins may also be used. Among these, cellulose films or acrylic films with surfaces saponified by alkali, etc., are particularly desirable considering their polarization characteristics or durability. Furthermore, the protective film may also serve the function of the optical layer described below.

In the present invention, the structure of the polarizing plate is not particularly limited and may comprise multiple types of optical layers laminated on the polarizer to satisfy the required optical characteristics. For example, it may have a structure in which a protective film protecting the polarizer is laminated on at least one surface of the polarizer, a structure in which a surface treatment layer, such as a hard coating layer, anti-reflective layer, anti-adhesion layer, anti-diffusion layer, or anti-glare layer, is laminated on at least one surface of the polarizer or on the protective film; or a structure in which an orientation liquid crystal layer that compensates for the viewing angle or another functional film is laminated on at least one surface of the polarizer or on the protective film. Furthermore, it may be a structure where one or more of an optical film such as a polarization converter device used to form various image display devices, a reflector, a semi-transparent plate, a phase plate including a half-wave plate or a quarter-wave plate (including a λ plate), a viewing angle compensation film, or a brightness enhancement film are stacked as optical layers. More specifically, it may be a polarizing plate with a protective film laminated on one surface of the polarizer, such as a reflective polarizing plate or a semi-transmissive polarizing plate where a reflector or a semi-transmissive reflector is laminated on the laminated protective film; an elliptical or circular polarizing plate with a phase plate laminated; a wide-viewing-angle polarizing plate with a viewing-angle compensation layer or a viewing-angle compensation film laminated; or a polarizing plate with a brightness enhancement film laminated, preferably.

This polarizing plate can be applied not only to conventional liquid crystal displays but also to various image display devices such as electroluminescent displays, plasma displays, and field emission displays. It is particularly effective for automotive displays or smart windows due to its excellent high-temperature heat resistance.

Smart windows comprising the polarizing plate of the present invention exhibit excellent high-temperature heat resistance. They can be used for automotive front windows, rear windows, side windows, sunroofs, or architectural windows. They can also be employed for interior space partitioning or privacy protection within vehicles or buildings.

Hereinafter, the present invention is described in greater detail by Examples. These Examples are intended solely to illustrate the present invention, and it will be apparent to those skilled in the art that the scope of the present invention is not limited to these Examples.

### Example 1: Preparation of a Polarizer

A transparent, non-stretched polyvinyl alcohol film (VF-PS, KURARAY) with a saponification degree of 99.9% or higher was immersed in water (deionized water) at 30° C. for 2 minutes to swell, and dyed by immersion in a dyeing aqueous solution containing 3.5 mM iodine and 2 wt % potassium iodide at 30° C. for 4 minutes. During this process, stretching was performed at stretching ratios of 1.3 times and 1.4 times during the swelling and dyeing steps, respectively. Subsequently, the film was crosslinked by immersion in a crosslinking aqueous solution containing 10 wt % potassium iodide, 3.7 wt % boric acid, and 3 wt % zinc nitrate at 53° C. for 2 minutes. The crosslinking step was performed to achieve a total cumulative stretching ratio of 5.8 times. Subsequently, in the complementary dyeing step, it was immersed for 10 seconds in a 50° C. complementary dyeing aqueous solution containing 10 wt % potassium iodide and 3.7 wt % boric acid. The complementary dyeing step was performed to achieve a total cumulative stretching ratio of 6 times. Immediately after cleaning for 20 seconds with a 10° C. cleaning aqueous solution, the film was irradiated with infrared rays of a wavelength of 2.5 μm using an infrared lamp at an energy of 0.16 J/cm² per unit area for 0.1 minutes. The polyvinyl alcohol film, after cleaning and infrared irradiation, was dried in an oven at 70° C. for 4 minutes to prepare the polarizer.

### Example 2: Preparation of a Polarizer

The polarizer was prepared by the same method as in Example 1, except that infrared rays were irradiated at an energy of 0.48 J/cm² per unit area.

### Example 3: Preparation of a Polarizer

The polarizer was prepared by the same method as in Example 1, except that infrared rays were irradiated at an energy of 0.72 J/cm² per unit area.

### Comparative Example 1: Preparation of a Polarizer

The polarizer was prepared by the same method as in Example 1, except that infrared rays were not irradiated onto the cleaned polyvinyl alcohol film.

### Comparative Example 2: Preparation of a Polarizer

The polarizer was prepared by the same method as in Example 1, except that infrared irradiation was performed after complementary dyeing but before cleaning.

### Comparative Example 3: Preparation of a Polarizer

The polarizer was prepared by the same method as in Example 2, except that infrared irradiation was performed after complementary dyeing but before cleaning.

### Comparative Example 4: Preparation of a Polarizer

The polarizer was prepared using the same method as in Example 1, except that infrared rays were irradiated at an energy of 0.04 J/cm² per unit area.

### Comparative Example 5: Preparation of a Polarizer

The polarizer was prepared using the same method as in Example 1, except that infrared rays were irradiated at an energy of 0.88 J/cm² per unit area.

### Comparative Example 6: Preparation of a Polarizer

The polarizer was prepared using the same method as in Example 3, except that no separate drying was performed on the polyvinyl alcohol film after cleaning and infrared irradiation.

### Experimental Example 1: Measurement of High-Temperature Heat Resistance

Polarizing plates were prepared by laminating triacetylcellulose (TAC) films onto both sides of the polarizers prepared in the above Examples and Comparative Examples. The physical properties of the prepared polarizing plates were measured using the following method, and the results are shown in Table 1 below.

### (1) Measurement of Single Color L*, a*, b*

After cutting the polarizing plate into 4 cm×4 cm pieces, the single color values L₁*, a₁*, b₁* were measured using an ultraviolet-visible spectrophotometer (V-7100, Japan Spectral Co., Ltd.). Subsequently, the polarizing plate with its color values measured was placed in an oven at 110° C. After 500 hours, it was removed from the oven, and the single color values L₂*, a₂*, and b₂* were measured.

### (2) Measurement of Color Change Before and After Heat Resistance Treatment

The color change before and after heat resistance treatment was measured by substituting the measured single color values L*, a*, and b* before and after heat resistance treatment into Equation 1 below.

$$Δ E = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} \qquad [ Equation 1 ]$$

TABLE 1

| | | Initial color before | | | Color after | | | |
|---|---|---|---|---|---|---|---|---|
| | Infrared | heat resistance treatment | | | heat resistance treatment | | | |
| | irradiation | Single L₁* | Single a₁* | Single b₁* | Single L₂* | Single a₂* | Single b₂* | ΔE |
| Example 1 | 0.16 J/cm² | 71.3 | −0.7 | 3.6 | 69.8 | −1.2 | 20.2 | 16.7 |
| | after cleaning | | | | | | | |
| Example 2 | 0.48 J/cm² | 71.3 | −0.7 | 3.4 | 70.6 | −1.1 | 18.0 | 14.6 |
| | after cleaning | | | | | | | |
| Example 3 | 0.72 J/cm² | 71.4 | −0.7 | 3.5 | 71.0 | −0.9 | 16.1 | 12.7 |
| | after cleaning | | | | | | | |
| Comparative | — | 71.3 | −0.8 | 3.5 | 68.9 | −1.1 | 25.2 | 21.9 |
| Example 1 | | | | | | | | |
| Comparative | 0.16 J/cm² | 71.2 | −0.8 | 3.6 | 67.7 | −1.6 | 24.5 | 21.2 |
| Example 2 | after | | | | | | | |
| | complementary | | | | | | | |
| | dyeing | | | | | | | |
| Comparative | 0.48 J/cm² | 71.3 | −0.7 | 3.6 | 69.0 | −1.7 | 24.9 | 21.5 |
| Example 3 | after | | | | | | | |
| | complementary | | | | | | | |
| | dyeing | | | | | | | |
| Comparative | 0.04 J/cm² | 71.3 | −0.7 | 3.5 | 69.6 | −1.2 | 25.1 | 21.6 |
| Example 4 | after cleaning | | | | | | | |
| Comparative | 0.88 J/cm² | Breakage | | | | | | |
| Example 5 | after cleaning | | | | | | | |
| Comparative | 0.72 J/cm² | 71.2 | −0.3 | 1.4 | 68.5 | −1.1 | 28.2 | 26.9 |
| Example 6 | after cleaning | | | | | | | |

As shown in Table 1 above, it was confirmed that the polarizing plates prepared using the polarizers of Examples 1 to 3, which were prepared by irradiating infrared rays with an energy of 0.16 to 0.72 J/cm² per unit area between the cleaning step and the drying step, exhibited minimal color change before and after heat resistance treatment at 110° C.

In contrast, the polarizing plates prepared using the polarizers of Comparative Examples 1 to 4 and 6, which were prepared without infrared irradiation, prepared by infrared irradiation before the cleaning step, prepared by infrared irradiation applying less than 0.16 J/cm² of energy per unit area between the cleaning and drying steps, or prepared without undergoing a drying step after infrared irradiation, respectively, exhibited significant color changes before and after heat resistance treatment at 110° C. Furthermore, the polarizer of Comparative Example 5, prepared by irradiating infrared rays with an energy exceeding 0.72 J/cm² per unit area between the cleaning and drying steps, suffered breakage during the preparing process, making it impossible to measure the color change of the polarizing plate.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. A process for preparing a polarizer, comprising the steps of swelling, dyeing, crosslinking, complementary dyeing, cleaning, and drying a film for forming a polarizer, which comprises the step of:
irradiating between the steps of cleaning and drying, infrared rays with an energy of 0.16 to 0.72 J/cm² per unit area to the film for forming a polarizer.

2. The process for preparing a polarizer according to claim 1, wherein the infrared rays have a wavelength of 1 to 5 μm.

3. The process for preparing a polarizer according to claim 1, wherein irradiation time of the infrared rays is 0.1 to 5 minutes.

4. The process for preparing a polarizer according to claim 1, wherein the film for forming a polarizer is a polyvinyl alcohol film.

5. A polarizer prepared by the preparation process according to claim 1.

6. A polarizing plate having a protective film laminated on at least one surface of the polarizer according to claim 5.

7. An automotive display comprising the polarizing plate according to claim 6.

8. A smart window comprising the polarizing plate according to claim 6.

9. The process for preparing a polarizer according to claim 2, wherein irradiation time of the infrared rays is 0.1 to 5 minutes.

10. The process for preparing a polarizer according to claim 2, wherein the film for forming a polarizer is a polyvinyl alcohol film.

11. A polarizer prepared by the preparation process according to claim 2.

12. A polarizer prepared by the preparation process according to claim 3.

13. A polarizer prepared by the preparation process according to claim 4.
